(19) United States
(12) Patent Application Publication
(10) Pub. No.: US 2006/0240980 A1
(43) Pub. Date: Oct. 26, 2006

(54) Polyporous material having nanoparticle and their preparation thereof

(76) Inventors: Shuo-Ting Hung, Taipei City (TW); Hong-Ming Lin, Taipei City (TW)

Correspondence Address: HARNESS, DICKEY & PIERCE, P.L.C., P.O. BOX 8910, RESTON, VA, 20195, US

(21) Appl. No.: 11/408,163

(22) Filed: Apr. 21, 2006

(30) Foreign Application Priority Data
Apr. 22, 2005 (TW) 094113007

(51) Int. Cl. C01B 31/08

(52) U.S. Cl. 502/417; 428/312.2; 428/312.8

(57) ABSTRACT

The present invention provides a method for preparing polyporous materials having nanoparticles. The present invention also provides polyporous material having nanoparticles.

### PRIORITY CLAIM

This application claims the priority of Taiwanese Patent Application No. 094113007, filed on Apr. 22, 2005, in the Taiwan Intellectual Property Office, the entire contents of which is incorporated herein by reference.

1. Field of the Invention

The present invention is related to a polyporous material having nanoparticles and a method for preparing the material.

2. Background of the Invention

Active carbon is a polyporous material which has tremendous BET (Brunauer-Emmett-Teller) surface area, strong absorbent, desulphurize, debenzene, deodorant, decolor, and selective elimination of some chemicals in liquid or gas phase. Silver-carried on the surface of active carbon can not only have the function of adsorbent but also of antiseptic. The function of antiseptic is mainly contributed by silver.

Silver has an ability of anti-bacteria. Ancient European and American put silver-decoration into fresh milk to elongate preservation time. This was the earliest actual example of applying anti-bacteria function of silver. Before finding penicillin, silver was taken as an age-old antibiotic. Various kinds of antibiotic-tolerance bacteria can be killed by colloidal silver (particle size is 10-100 nm).

According to the results of long-term international studies, there are many kinds of metals can kill bacteria result from their redox capability. Silver is the one that utilized for environmental anti-bacteria. This characteristic makes silver has strong and prolonged antiseptic effect which is related to its germproof nature. Positive charge on the surface of nanosilver particles can easily incorporate tightly with cell wall/membrane of bacteria. Therefore nanosilver particles can get into germ directly and combine with sulfhydryl group of oxygenic metabolism and inactivity the metabolism of bacteria that can not harm human body further.

Silver is selected to be the prior anti-bacteria material just because it is not only germproofing but also health protection for human body (protects natural enzymes inside our bodies and accelerates the mending of the torn tissues).

Therefore, someone integrates well adsorbability of active carbon with antiseptic characteristic of silver to form silver-carried active carbon that silver is bound to the surface of the active carbon. Recently, although recently commercial products of silver-carried active carbon are inorganic bactericide that have broad utilities, nice antiseptic, and no drug-tolerance to microorganism, most silver of the present silver-carried active carbon are not nano-grade silver that reduce effect of antiseptic owing to the corased grain of silver. The plating silver is prone to fall off due to over amount of silver which causes second environmental pollution, also shorter lifetime of antiseptic. These are many problems needed to be overcome by industrial research.

### BRIEF DESCRIPTION OF THE DRAWINGS

FIG. 1 shows picture of electron microscope which is nanosilver deposited active carbon with 1200 m²/g of BET.

FIG. 2(a) shows data of nanosilver deposited active carbon analyzed by EDS assay from FIG. 1, which confirms nanosilver particles grew on the surface of active carbon.

FIG. 2(b) shows spectrum of nanosilver deposited active carbon analyzed by EDS assay from FIG. 1, which indicates element amount on the surface of active carbon.

FIG. 3 shows picture of electron microscope which is nanosilver deposited active carbon with 1500 m²/g of BET.

FIG. 4(a) shows spectrum of nanosilver deposited active carbon analyzed by EDS assay from FIG. 3, which indicates element amount on the surface of active carbon.

FIG. 4(ba) shows data of nanosilver deposited active carbon analyzed by EDS assay from FIG. 3, which confirms nanosilver particles grew on the surface of active carbon.

FIG. 5(a) shows example of nanosilver deposited glass beads and data of EDS assay confirm that nanosilver particles are grown on the surface of the glass beads.

FIG. 5(b) shows spectrum of nanosilver deposited glass beads and data of EDS assay which indicates element amount on the surface of active carbon.

FIG. 6 shows test of inhibiting E. coli.

### DETAILED DESCRIPTION OF THE INVENTION

The present invention provides a method for preparing a polyporous material having a nanoparticle such nanosilver particle belongs to inorganic particle. The polyporous material of the present invention is made by mixing solvent of solving nanomaterial with a nanomaterial precursor to form a mixture and then adding a quantified polyporous material into the mixture. After combining materials mentioned above, the mixture is mixed thoroughly while heating. After the heating process is completed, the polyporous material is taken out and rinsed by cleaning solution to remove superfluous non-reactive nanomaterial. Finally, the polyporous material is taken out and stood to complete the crystal growth on the surface of the material.

Therefore, this invention provides a method of preparing a polyporous material having a nanoparticle, including:
(a) mixing a solvent of solving nanomaterial with a nanomaterial precursor;
(b) adding mixture of (a) into quantified polyporous material;
(c) heating mixture of (b) at range of 60˜150° C.;
(d) utilizing a washing solution to wash polyporous material, and remove precursor of nanomaterial and reactant; and
(e) standing polyporous material to complete the crystalization on the surface of the polyporous material.

In the method of the present invention, the ratio on the nanomaterial precursor to the solvent of solving nanomaterial is 0.001˜1.5 wt % and the preferred ratio is 0.05˜1 wt %; the ratio on the nanomaterial precursor to the polyporous material is 0.001˜2.0 wt % and the preferred ratio is 0.01˜1 wt %. The solvent of solving nanomaterial comes from aqueous solution or deionized water. The washing solution can be diluted hydrochloric acid solution, water or distilled water.

General heating temperature of the polyporous material mixture is 60˜150° C.; the preferred heating temperature is 90˜120° C.; the most preferred heating temperature is 110° C. The heating time is 30˜100 minutes; preferably heating time is 50˜80 minutes.

The solution of rinsing polyporous materials grown with nanocrystal is diluted hydrochloric acid solution. The nanomaterial precursor mentioned above comes from silver nitrate, silver acetate, silver bromide, silver lactate, silver chloride, silver fluoride, silver iodide, silver sulfate, or silver phosphate. The most preferred nanomaterial precursor comes from silver nitrate. In addition, nanocrystal is a nanometal particle. Nanosilver particle is the most preferred nanometal particle.

The concentration range of silver nanoparticle is 0.005 to 1000 ppm; the preferred concentration range of silver nanoparticle is 30 to 100 ppm; the most preferred concentration of silver nanoparticle is 40 ppm. Furthermore, the size range of the particle is 1 to 900 nm.

The polyporous material mentioned above is selected from the group consisting of porcelain, active carbon, glass ball, porous glass, Tenax-TA, bamboo charcoal, coconut shell-based active carbon, and charcoal and their derivatives. The preferred polyporous material is active carbon. The active carbon is selected from the group consisting of powdered active carbon, granular active carbon, fibered active carbon, columnar active carbon, and honeycomb shape active carbon. The size of that is 1 to 500 meshes, the preferred is 10 to 500 meshes; the most preferred is 40 to 100 meshes.

According to China patent application No 93106057.5 discloses a method for preparing a silver-carried active carbon. The method of mixing active carbon and silver nitrate solution, in addition to adding silver bromide solution to make silver be carried on the active carbon to raise antiseptic and deodorization effects of the active carbon. However, the practical production and analysis discover that the silver of silver-carried active carbon is not pure silver particle but silver compounds. Silver compounds easily block the holes and gaps on the surface of the active carbon produced by China patent to reduce BET. Additionally, silver compounds are easily dropped to may cause second pollution and make the lower effects of deodorization and antiseptic.

To the contrary, the present invention combines nanotechnology, crystallize technology and the metal nature of silver to grow nanosilver particle on the surface of active carbon. Except of pure silver, nanosilver particles provide nano-grade particles to make BET of the active carbon not only close to original BET of the active carbon but also significantly increasing the effect and lifetime of deodorant, anti-bacteria of the original active carbon.

Accordingly, the present invention provides a polyporous material having a nanoparticle which is prepared by the method of the present invention.

The nanomaterial precursor mentioned above is selected from the group consisting of silver nitrate, silver acetate, silver bromide, silver lactate, silver chloride, silver fluoride, silver iodide, silver sulfate and silver phosphate. In addition, nanoparticle is a nanometal particle. The most preferred nanometal particle is nanosilver particle.

The concentration range of silver nanoparticle is 0.005 to 1000 ppm; the preferred concentration range of silver nanoparticle is 30 to 100 ppm; the most preferred concentration of silver nanoparticle is 40 ppm. Furthermore, the size range of the particle is 1 to 900 nm.

The polyporous materials of the present invention can apply to deodorization, antiseptic, recycled solution, catalysis carrier, absorbance of gas or liquid, filtration and clean of gas or liquid, decolorant of various medicines, preservation or refining of food, filter, filter net of air conditioner, filter net of stove, filter net of air cleaner, filter composition of aquarium, fiber cloth made of active carbon, additions of clean appliance and the like various types of stuff material of industrial poison-guard appliances or active carbon mask.

The polyporous material of the present invention can apply to active carbon. It can be used for a closed space, such as refrigerator, shoe cabinet, bathroom, clothes closet, clothes chest, acceptive box, maintain fresh box, bookcase, liquors cabinet, drawer, depository, garage, basement, cupboard, kitchen, storehouse, room, box in a KTV, cabin, and town bus.

The examples below are non-limiting and are merely representative of various aspects and features of the present invention.

### EXAMPLE

### Example 1

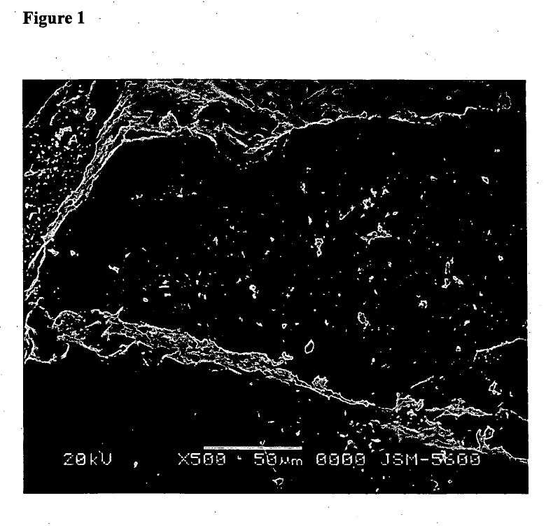

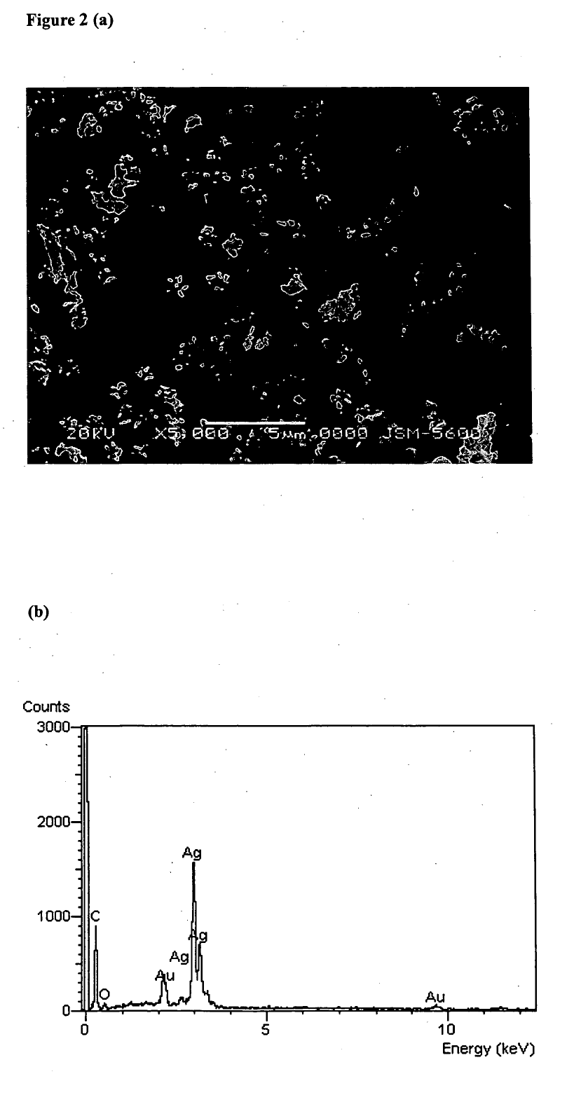

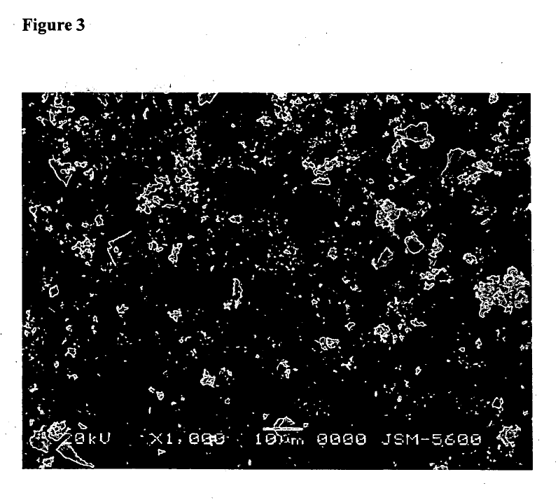

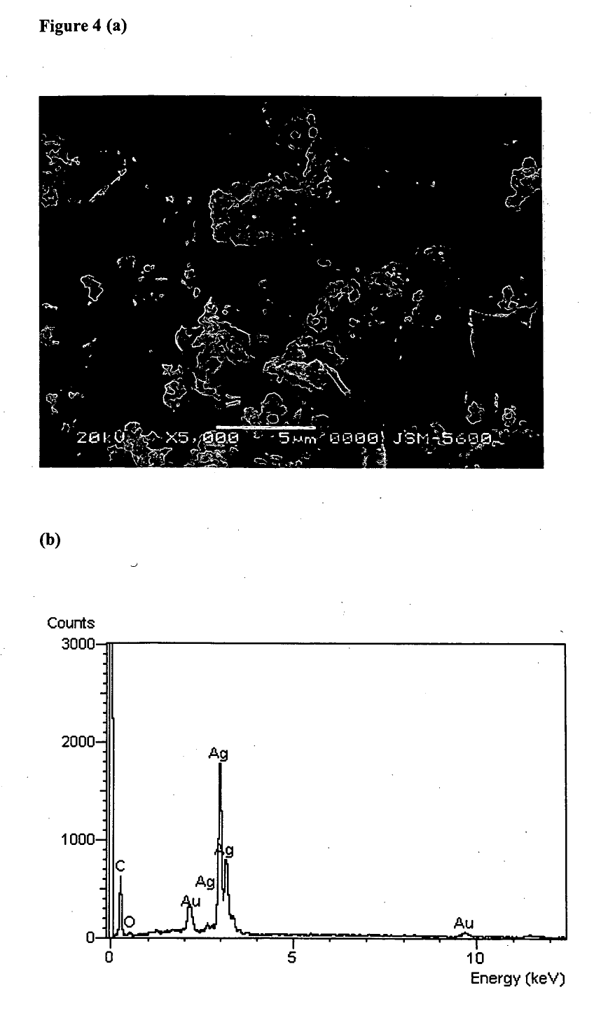

Deionized water, silver nitrate, and active carbon with 1200 m²/g of BET were mixed according to the weight ratio of 200:0.5:10. The mixture was mixed thoroughly and was heated to 110° C. The mixture was kept under constant temperature over one hour. Then active carbon with 1200 m²/g of BET was taken and rinsed with diluted HCl solution. After that, nanosilver particles were grew on the surface of the active carbon. As shown in FIGS. 1, 2(A), (B), nanosilver particles were actually grown on the surface of the active carbon with 1200 m²/g of BET.

### Example 2

Deionized water, silver nitrate, and active carbon with 1500 m²/g of BET according to the volume ratio 200:0.5:10. The mixture was mixed thoroughly and was heated to 115° C. The mixture was kept under constant temperature over one hour. Then active carbon with 1500 m²/g of BET was taken and rinsed with diluted HCl solution. After that, nanosilver particles were grown on the surface of the active carbon. As shown in FIGS. 1, 2(A), (B), nanosilver particles were actually grown on the surface of the active carbon with 1500 m²/g of BET.

### Example 3

### Testing of BET

BET analyzer was used to measure the BET surface area of samples A, B, C and D. The specification of each sample was: A represented active carbon with 1200 m²/g of BET; B represented active carbon with 1500 m²/g of BET; C represented nanosilver deposited active carbon with 1200 m²/g of BET; D represented nanosilver deposited active carbon with 1500 m²/g of BET.

Four samples A, B, C and D were divided into 2 groups. And compared with the groups, it was found that there was slightly different in BET surface area between grown nanosilver particle on the active carbon, and non-treated active carbon.

| | In P/P₀0.21535063 (m²/g) | BET surface | Langmuir surface |
|---|---|---|---|
| | single point surface area | area (m²/g) | area (m²/g) |
| A | 843.23 | 821.32 | 1112.83 |
| B | 1086.13 | 1079.70 | 1460.98 |
| C | 806.72 | 787.39 | 1065.66 |
| D | 1059.88 | 1054.13 | 1421.73 |

### Example 4

### Adsorbent Test

Four samples A, B, C and D were compared with adsorbent ratio of n-butane by the use of microbalance. A sample represented nanosilver deposited on active carbon with 1200 m²/g of BET. B sample represented nanosilver deposited on active carbon with 1500 m²/g of BET. C sample represented active carbon with 1200 m²/g of BET. D sample represented active carbon with 1500 m²/g of BET. Data were measured as following:

| | | Samples | | | |
|---|---|---|---|---|---|
| | Items | A | B | C | D |
| 1 | Weight of active carbon (g) | 9.55 | 8.52 | 9.89 | 8.86 |
| 2 | Weight of active carbon | 11.29 | 10.62 | 11.58 | 10.75 |
| | after saturated absorbing (g) | | | | |
| 3 | ratio of adsorbent | 18.20 | 24.60 | 17.07 | 21.33 |
| | efficiency of n-butane (%) | | | | |
| 4 | ratio of adsorbent | 46.41 | 62.73 | 43.53 | 54.39 |
| | efficiency of carbon | | | | |
| | tetrachloride (%) | | | | |

* ratio of adsorbent efficiency (%) = (weight after saturating adsorbent − weight of original active carbon) ÷ weight of original active carbon

Compared n-butane with carbon tetrachloride by adsorbent efficiency can easily be showed that adsorbent ratio of active carbon was higher than untreated active carbon. Therefore, the compound adsorbent efficiency and deodorization of the present invention were better than known active carbon.

### Example 5

### Glass Beads with Nanosilver

Chemical component on the surface of glass beads with nanosilver particles were analyzed by EDS assay. The results were as follows:

| Elements | Element percentage (%) | Atom percentage (%) |
|---|---|---|
| C K | 19.42 | 32.23 |
| O K | 24.94 | 31.07 |
| Na K | 5.12 | 4.44 |
| Mg K | 2.08 | 1.70 |
| Al K | 1.54 | 1.14 |
| Si K | 31.94 | 22.66 |
| Cl K | 0.51 | 0.29 |
| Ca K | 12.15 | 0.04 |
| Ag I | 2.30 | 0.42 |
| Total | 100.00 | 100.00 |

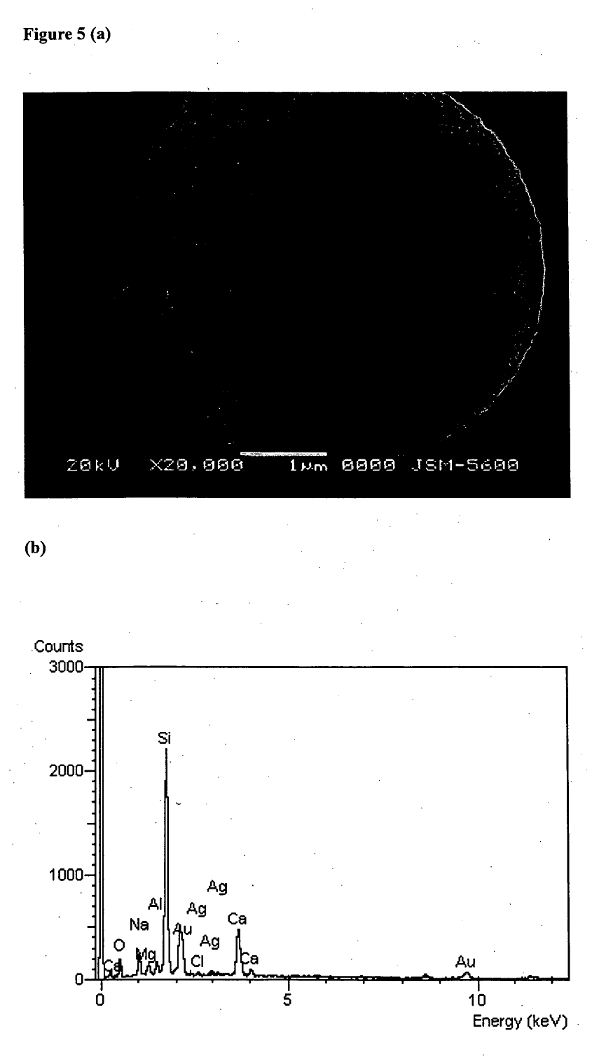

As shown in FIG. 5, nanosilver actually grew on the surface of glass beads.

### Example 6

### Anti-Septic Test

E. coli were transferred into LB broth to cultivate bacteria seeding number until 1.96×10⁷, and added the concentration listed in the below table into broth respectively as active carbon with 1200, 1500 m²/g of BET, T9 (active carbon with 1200 m²/g of BET having nanosilver), and T10 (active carbon with 1500 m²/g of BET having nanosilver). Then flask was shaken and incubated over 16 hours.

TABLE 1
result of anti-septic test

| Concentration | BET 1200 | BET 1500 | T9 | T10 |
|---|---|---|---|---|
| 1% | X | X | V | V |
| 0.24% | X | X | V | V |
| 0.05% | X | X | V | V |
| 0.026% | X | X | V | V |

* X represented no anti-septic effect
V represented no anti-septic effect

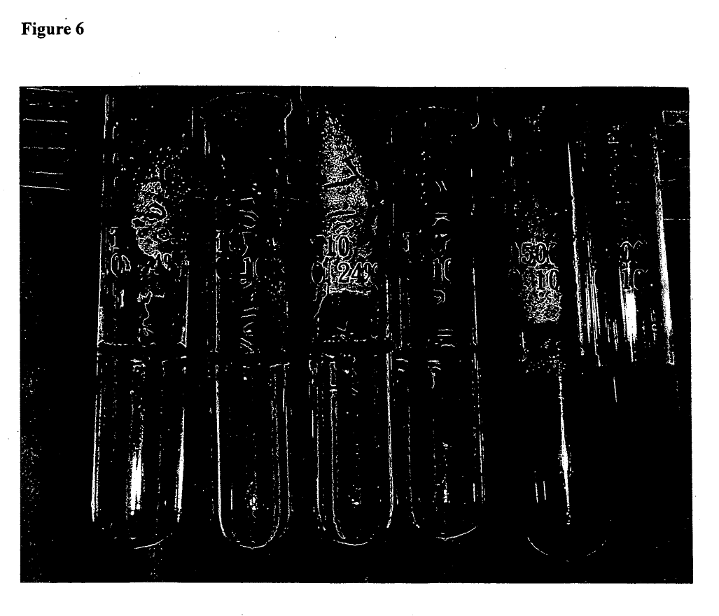

As shown in FIG. 6, the result of active carbon with 1200 and 1500 m²/g of BET did not inhibit bacterial growth. The polyporous materials having nanoparticles T9 and T10 of the present invention inhibited bacterial growth under concentration of 0.026 % to 1%.

### Example 7

Deionized water, silver nitrate, and active carbon with 1200 m²/g of BET were mixed according to the weight ratio of 60:0.5:10. The mixture was mixed thoroughly and was heated to 100° C. The mixture was kept under constant temperature over 30 minutes. Then active carbon with 1200 m²/g of BET was taken and rinsed with deionized water. After that, nanosilver particles were grew on the surface of the active carbon.

### Example 8

Deionized water, silver nitrate, and active carbon with 1500 m²/g of BET according to the volume ratio 60:0.5:10. The mixture was mixed thoroughly and was heated to 100° C. The mixture was kept under constant temperature over 30 minutes. Then active carbon with 1500 m²/g of BET was taken and rinsed with deionized water. After that, nanosilver particles were grown on the surface of the active carbon.

One skilled in the art readily appreciates that the present invention is well adapted to carry out the objects and obtain the ends and advantages mentioned, as well as those inherent therein. The processes and methods for producing nanoparticles are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations, which are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method for preparing a polyporous material having a nanoparticle including the following steps:
(a) mixing a solvent of solving nanomaterial with a nanomaterial precursor;
(b) adding mixture of (a) into quantified polyporous material;
(c) heating mixture of (b) at range of 60˜150□;
(d) utilizing washing solution to wash polyporous material, and remove precursor of nanomaterial and reactant; and
(e) standing the polyporous material to complete the crystalization on the surface of the polyporous material.

2. The method of claim 1, wherein the nanomaterial precursor and the solvent of solving nanomaterial have the weight ratio of 0.001˜1.5%.

3. The method of claim 1, wherein the nanomaterial precursor and the polyporous material have the weight ratio of 0.001˜2.0%.

4. The method of claim 1, wherein the heating requires 30100 minutes.

5. The method of claim 1, wherein the washing solution is a solution of diluted hydrochloric acid, water or distilled water.

6. The method of claim 1, wherein the solvent of solving nanomaterial is water solution or distilled water.

7. The method of claim 1, wherein the nanomaterial precursor is selected from the group consisting of silver lactate, silver acetate, silver nitrate, silver bromide, silver chloride, silver fluoride, silver iodide, silver sulfate and silver phosphate.

8. The method of claim 1, wherein the nanoparticle is a nanometal particle.

9. The method of claim 8, wherein the crystal of nanometal particle is nanosilver particle.

10. The method of claim 9, wherein the nanosilver particle is in size of 1˜900 nm.

11. The method of claim 9, wherein the nanosilver particle is in concentration of 0.005˜1000 ppm.

12. The method of claim 1, wherein the polyporous material is selected from the group consisting of porcelain, active carbon, glass ball, porous glass, Tenax-TA, bamboo charcoal, coconut shell-based active carbon and charcoal and its derivatives.

13. The method of claim 12, wherein the active carbon is selected from the group consisting of powdered active carbon, granular active carbon and fibered active carbon.

14. A polyporous material having a nanoparticle which is prepared by the method of claim 1.

15. The polyporous material of claim 14, wherein the precursor of nanomaterial is selected from the group consisting of silver lactate, silver acetate, silver nitrate, silver bromide, silver chloride, silver fluoride, silver iodide, silver sulfate and silver phosphate.

16. The polyporous material of claim 14, wherein the nanoparticle is nanosilver.

17. The polyporous material of claim 16, wherein the nanosilver is in the range of 1 to 900 nm of the diameter.

18. The polyporous material of claim 16, wherein the nanosilver is 0.005˜1000 ppm in concentration.

19. The polyporous material of claim 14, which can apply to deodorization, antiseptic, recycled solution, catalysis carrier, absorbance of gas or liquid, filtration and clean of gas or liquid, decolorant of various medicines, preservation or refining of food, filter, filter net of air conditioner, filter net of stove, filter net of air cleaner, filter composition of aquarium, fiber cloth made of active carbon, additions of clean appliance and the like various types of stuff material of industrial poison-guard appliances or active carbon mask.

20. The polyporous material of claim 14, which can be used for the closed space, refrigerator, shoe cabinet, bathroom, clothes closet, clothes chest, acceptive box, maintain fresh box, bookcase, liquors cabinet, drawer, depository, garage, basement, cupboard, kitchen, storehouse, room, box in a KTV, cabin, and town bus.
